(19) United States
(12) Patent Application Publication
(10) Pub. No.: US 2012/0021339 A1
(43) Pub. Date: Jan. 26, 2012

(54) SOLID OXIDE FUEL CELL AND MANUFACTURING METHOD THEREOF

(75) Inventors: Han Wool RYU, Seoul (KR); Jae Hyuk JANG, Seoul (KR); Hong Ryul LEE, Gyunggi-do (KR)

(73) Assignee: SAMSUNG ELECTRO-MECHANICS CO., LTD., Gyunggi-do (KR)

(21) Appl. No.: 13/048,734

(22) Filed: Mar. 15, 2011

(30) Foreign Application Priority Data
Jul. 26, 2010 (KR) 10-2010-0072093

(51) Int. Cl. H01M 4/48; H01M 8/00

(52) U.S. Cl. 429/532; 429/535

(57) ABSTRACT

Disclosed herein are a solid oxide fuel cell and a manufacturing method thereof. The solid oxide fuel cell includes: an anode layer, a cathode layer, and an electrolyte layer interposed between the anode layer and the cathode layer, wherein the anode layer includes: a conductive material; yttria stabilized zirconia (YSZ); and an oxide compound for forming a solid solution with the yttria stabilized zirconia.

### CROSS REFERENCE TO RELATED APPLICATION

This application claims the benefit of Korean Patent Application No. 10-2010-0072093, filed on Jul. 26, 2010, entitled “Solid Oxide Fuel Cell And Manufacturing Method Thereof” which is hereby incorporated by reference in its entirety into this application.

### BACKGROUND OF THE INVENTION

1. Technical Field

The present invention relates to a solid oxide fuel cell and a manufacturing method thereof.

2. Description of the Related Art

A solid oxide fuel cell is operated at the highest temperature (700 to 1000) among the fuel cells by using a solid oxide having oxygen or hydrogen ion conductivity as an electrolyte as well as has a simpler structure than other fuel cells, does not cause problems such as loss, supplement, and corrosion of an electrolyte, does not require a precious metal catalyst, and easily supplies fuel through the direct internal reforming since all components are formed of a solid.

Further, the solid oxide fuel cell can perform thermal hybrid generation using waste heat due to the discharge of the high-temperature gas. Researches into the solid oxide fuel cell have been actively conducted to be commercialized in the early 21^{st} century in advance countries, such as the United States of America, Japan, or the like.

The general solid oxide fuel cell is configured to include an electrolyte layer in which oxygen ion conductivity is high and porous cathode and anode layers are positioned on both sides thereof.

The operational principle generates water by arriving oxygen passing through a porous cathode at an electrolyte surface, moving oxygen ion generated by a reducing reaction of oxygen through a dense electrolyte, and reacting it with hydrogen supplied to a porous anode. At this time, electrons are generated in the anode and consumed in the cathode, such that two electrodes are connected to each other to move electricity.

In the fuel cell, it is important to increase the efficiency of the fuel cell by improving the porosity of the porous cathode and anode through which oxygen and hydrogen pass and increasing gas permeability.

However, the porous electrode of the anode has a problem of reducing the intensity of the electrode in proportion to the porosity. The reduction in the intensity of the anode electrode reduces the mechanical lifespan of the fuel cell, which is considered as the problem to be solved in the unit cell of the fuel cell. That is, the fuel cell should secure long durability of 400,000,000 hours.

A yttria stabilized zirconia (YSZ) material used in the related art mainly uses zirconia stabilized with 8 mol % of yttria (hereinafter, referred to as ‘8YSZ’) having excellent oxygen ion conductivity, which has been known as having excellent oxygen ion conductivity but intensity that is lower four times than that of zirconia (hereinafter, referred to as ‘3YSZ’) stabilized with 3 mol % of yttria.

The oxygen ion conductivity of YSZ is due to oxygen vacancy concentration and the intensity is due to volume expansion (increase by about 4.5%) by martensitic transformation from a tetragonal phase into monoclinic phase.

Meanwhile, the solid oxide fuel cell is mainly used an anode support type in view of the intensity and economical aspect. The electrochemical reaction of the solid oxide fuel cell is generated in the supplied gas, and the electrolyte, the triple phase boundary of the electrode. The area of the triple phase boundary and the high ion conductivity of the electrolyte and the electrode have a large effect on the characteristics of the fuel cell.

The material of the support portion requires excellent electric conductivity, ion conductivity, porosity, and intensity. In particular, when the 3YSZ having low ion conductivity is used, ion conductivity is degraded at the triple phase boundary. In order to improve this, the improvement of the ion conductivity is needed.

Therefore, as a material taking charge of the portion supporting the anode in the anode support type solid oxide fuel cell, a material having new compositions capable of improving electrical characteristics such as high ion conductivity is needed in the existing YSZ composite having excellent mechanical strength.

### SUMMARY OF THE INVENTION

The present invention has been made in an effort to provide a solid oxide fuel cell having high intensity and high ion conductivity by introducing 3YSZ having high intensity into an anode of a fuel cell and adding an oxide compound capable of forming solid solution with YSZ such as Ln₂O₃ type additives to improve reduced ion conductivity according to 3YSZ additional amount, and a manufacturing method thereof.

The present invention has been also made in an effort to provide a solid oxide fuel cell capable of sufficiently satisfying requirements as a material taking charge of the support portion in an anode support fuel cell by adding an oxide compound for forming a solid solution in a high-intensity anode support including 3YSZ and optionally, 8YSZ to improve reduced ion conductivity according to the 3YSZ additional amount, and a manufacturing method thereof.

A solid oxide fuel cell according to a preferred embodiment of the present invention includes: an anode layer, a cathode layer, and an electrolyte layer interposed between the anode layer and the cathode layer, wherein the anode layer includes: a conductive material; yttria stabilized zirconia (YSZ); and an oxide compound for forming a solid solution with the yttria stabilized zirconia.

The yttria stabilized zirconia may include zirconia stabilized with 3 mol % of yttria (3YSZ).

The yttria stabilized zirconia may include 25 to 100 wt % of zirconia stabilized with 3 mol % of yttria (3YSZ) and 0 to 75 wt % of zirconia stabilized with 8 mol % of yttria (8YSZ).

The oxide compound for forming the solid solution may be selected from a group consisting of Ln₂O3, CeO₂, CaO, and a mixture thereof and the Ln may be Yb, Er, Dy, Gd, Sc, Sm, Ga, Bi, or Nd.

The oxide compound for forming the solid solution may be included as the content of 0.1 to 20 parts by weight for every 100 parts by weight of the yttria stabilized zirconia.

The conductive material may be Ni, Co, Fe, or a mixture thereof.

According to a preferred embodiment of the present invention, the anode layer may include an anode supporting layer and an anode functional layer.

The anode supporting layer may include: a conductive material; yttria stabilized zirconia; and an oxide compound for forming a solid solution with the yttria stabilized zirconia.

The yttria stabilized zirconia may include zirconia stabilized with 3 mol % of yttria (3YSZ) and zirconia stabilized with 8 mol % of yttria (8YSZ).

The yttria stabilized zirconia may include 25 to 100 wt % of zirconia stabilized with 3 mol % of yttria (3YSZ) and 0 to 75 wt % of zirconia stabilized with 8 mol % of yttria (8YSZ).

The oxide compound for forming the solid solution may be selected from a group consisting of Ln₂O₃, CeO₂, CaO, and a mixture thereof, and the Ln may be Yb, Er, Dy, Gd, Sc, Sm, Ga, Bi, or Nd.

The oxide compound for forming the solid solution may be included as the content of 0.1 to 20 parts by weight for every 100 parts by weight of the yttria stabilized zirconia.

A method for manufacturing a solid oxide fuel cell according to another preferred embodiment of the present invention includes: forming an anode layer; forming an electrolyte layer on the anode layer; and forming a cathode layer on the electrolyte layer, wherein the anode layer includes: a conductive material; yttria stabilized zirconia; and an oxide compound for forming a solid solution with the yttria stabilized zirconia.

The forming the anode layer may include: forming an anode supporting layer; and forming an anode functional layer on the anode supporting layer.

The anode supporting layer may include: a conductive material; yttria stabilized zirconia; and an oxide compound for forming a solid solution with the yttria stabilized zirconia.

The method for manufacturing a solid oxide fuel cell may further include sintering products resulted after the forming the anode layer, the forming the electrolyte layer, and the forming the anode layer, respectively.

### BRIEF DESCRIPTION OF THE DRAWINGS

FIG. 1 is a schematic cross-sectional view for explaining a solid oxide fuel cell according to a preferred embodiment of the present invention; and

FIG. 2 is a schematic cross-sectional view for explaining a solid oxide fuel cell according to another preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first,” “second,” and so on are used to distinguish one element from another element, and the elements are not defined by the above terms.

Hereinafter, preferred embodiments of the present invention will be described in detail with reference to the accompanying drawings.

Solid Oxide Fuel Cell

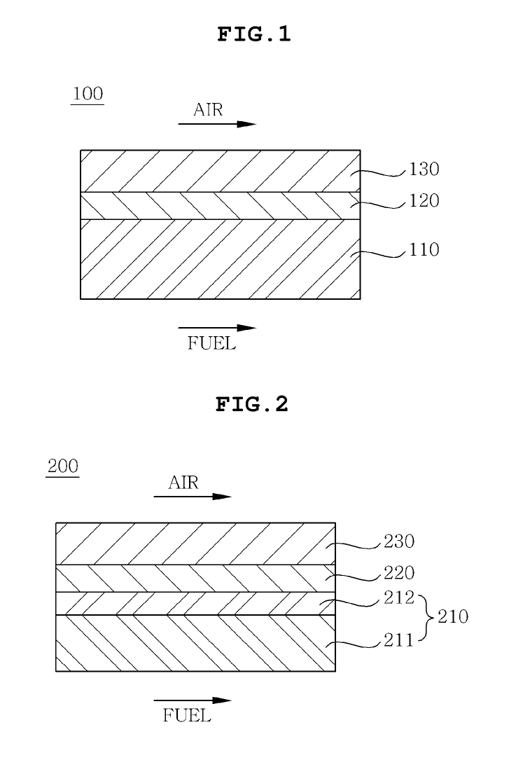

FIG. 1 is a schematic cross-sectional view for explaining a solid oxide fuel cell according to a preferred embodiment of the present invention and FIG. 2 is a schematic cross-sectional view for explaining a solid oxide fuel cell according to another preferred embodiment of the present invention.

Hereinafter, a solid oxide fuel cell according to a preferred embodiment of the present invention will be described with reference to FIG. 1.

A solid oxide fuel cell 100 according to a preferred embodiment of the present invention includes an anode layer 110, a cathode layer 130, and an electrolyte layer 120 interposed between the anode layer 110 and the cathode layer 130.

The anode layer 110 receives fuel to generate current and collects the generated current to supply electric energy to external circuits.

The anode layer 110 includes a conductive material, yttria stabilized zirconia, and an oxide compound for forming a solid solution with the yttria stabilized zirconia.

The conductive material, which serves as a conductor of the anode for the fuel cell, may generally be one or more oxide compound selected from Ni, Co, and Fe, but is not specifically limited thereto.

The yttria stabilized zirconia may include zirconia stabilized with 3 mol % of yttria (3YSZ).

The yttria stabilized zirconia may optionally include zirconia stabilized with 8 mol % of yttria (8YSZ), together with 3YSZ.

Preferably, the yttria stabilized zirconia may include 25 to 100 wt % of 3YSZ and 0 to 75 wt % of 8YSZ.

The 8YSZ, which is a material used for the anode electrode, has excellent oxygen ion conductivity while having relatively low mechanical strength.

Therefore, the present invention uses 3YSZ in order to improve the intensity of the anode.

In this case, the usage of each of the 3YSZ and 8YSZ is preferably 25 to 100 wt % and 0 to 75 wt %, which is suitable to improve the intensity and ion conductivity.

Meanwhile, the 3YSZ has excellent mechanical strength but has relatively low oxygen ion conductivity. Therefore, the present invention improves ion conductivity of the high-intensity anode with the reinforced mechanical physical property according to the introduction of 3YSZ by adding the oxide compound for forming the solid solution with the YSZ to improve the electrical characteristics, thereby making it possible to provide the anode including both the excellent intensity and ion conductivity.

The oxide compound for forming the solid solution with the yttria stabilized zirconia may be selected from any one of Ln₂O₃, CeO₂, and CaO or a mixture of two or more thereof. In this case, the Ln is Yb, Er, Dy, Gd, Sc, Sm, Ga, Bi, or Nd. However, the oxide compound for forming the solid solution is not limited to the above-mentioned example and therefore, any oxide compounds known to those skilled in the art can be used.

The oxide compound for forming the solid solution is included as the content of 0.1 to 20 parts by weight for every 100 parts by weight of the yttria stabilized zirconia, which is suitable to obtain the desired electrical characteristics as compared to the efficiency.

The fuel cell using the above-mentioned anode of the present invention can prevent the defect of the anode layer and reduce the thickness of the unit cell included in the solid oxide fuel cell, due to having excellent intensity and electrical characteristics even though the solid oxide fuel cell is used for a long period of time.

The electrolyte layer 120 is formed between the anode layer 110 and the cathode layer 130.

The electrolyte layer 120 passes only protons to the cathode layer 130 without passing through current, when hydrogen is, for example, used as fuel.

The electrolyte layer 120, which is the solid oxide electrolyte layer, has lower ion conductivity as compared to the liquid electrolyte such as an aqueous solution or a molten salt to reduce the voltage drop due to resistance polarization. Therefore, the electrolyte layer is formed to be maximally thin.

The electrolyte layer 120 may use the same material as the ion conductive oxide compound used for the anode layer 110. For example, the electrolyte layer may be made of YSZ such as 8YSZ or ceramic materials such as scandium stabilized zirconia (ScSZ), GDC, LDC, Ceria doped with samarium (Sm), or the like, but is not specifically limited thereto.

The cathode layer 130 is formed on the electrolyte layer 120. Water is generated by a combination of protons transferred from the electrolyte layer 120, electrons transferred through the external circuits, and oxygen in the air. The cathode layer 130 may use, for example, lanthanum (La), magnesium (Mn), oxide (La₁₋ₓSrₓMnO₃, hereinafter, referred to as LSM) added with strontium (Sr) including a perovskite structure (AB03, A=rare earth and alkali earth metal, B=transition metal, O=oxygen) or a composite of LSM/YSZ. However, the present invention is not limited thereto.

Meanwhile, the solid oxide fuel cell 100 includes the anode layer 110, the electrolyte layer 120, and the cathode layer 130 but may be manufactured in various shapes such as a flat shape, a cylindrical shape, etc. Therefore, the solid oxide fuel cell 100 is not limited to the fuel cell having a specific shape.

Hereinafter, a solid oxide fuel cell according to another preferred embodiment of the present invention will be described with reference to FIG. 2. However, the description of the same components as the preferred embodiment will be omitted.

A solid oxide fuel cell 200 according to another preferred embodiment of the present invention includes an anode layer 210, a cathode layer 230, and an electrode layer 220 interposed between the anode layer 210 and the cathode layer 230, wherein the anode layer 210 includes an anode supporting layer 211 and an anode functional layer 212.

The anode supporting layer 211 has typically porous properties transmitting gas to supply fuel to the anode functional layer 212, while supporting the anode functional layer 212.

The anode supporting layer 211 and the anode functional layer 212 may be made of the same host material. The host material may be made as described above in the anode layer according to the preferred embodiment.

As described above, the present invention adds the oxide compound for forming the solid solution with the YSZ to the high-intensity anode or an anode support with the reinforced mechanical properties by appropriately mixing the 3YSZ component with the 8YSZ component in order to improve low ion conductivity, thereby making it possible to provide the solid oxide fuel cell including the anode having high-intensity and high-ion conductivity.

Method of Manufacturing Solid Oxide Fuel Cell

A method for manufacturing a solid oxide fuel cell according to a preferred embodiment of the present invention includes forming the anode layer, forming the electrolyte layer on the anode layer, and forming the cathode layer on the electrolyte layer.

The anode layer may be formed by molding a raw mixing powder in a desired shape such as a cylindrical shape or a flat shape by, for example, an extruding method, etc., and sintering it but is not specifically limited thereto.

The raw mixing power may further include a binder, a porosity aid, other additives, etc., that are known to those skilled in the art, in addition to the conductive material, the yttria stabilized zirconia, and functional component such as a precursor of the oxide compound for forming the solid solution with the yttria stabilized zirconia.

The anode layer 110 formed as described above includes the conductive material, the yttria stabilized zirconia, and the oxide compound for forming the solid solution with the yttria stabilized zirconia.

The conductive material, which serves as a conductor of the anode for the fuel cell, may generally be one or more oxide compound selected from Ni, Co, and Fe, but is not specifically limited thereto.

The yttria stabilized zirconia may include zirconia stabilized with 3 mol % of yttria (3YSZ).

The yttria stabilized zirconia may optionally include zirconia stabilized with 8 mol % of yttria (8YSZ), together with 3YSZ.

Preferably, the yttria stabilized zirconia may include 25 to 100 wt % of 3YSZ and 0 to 75 wt % of 8YSZ.

The 8YSZ, which is a material used for the anode electrode, has excellent oxygen ion conductivity but has the relatively low mechanical strength.

Therefore, the present invention uses 3YSZ in order to improve the intensity of the anode.

In this case, the usage of each of the 3YSZ and 8YSZ is preferably 25 to 100 wt % and 0 to 75 wt %, which is suitable to improve the intensity and ion conductivity.

Meanwhile, the 3YSZ has excellent mechanical strength but has relatively low oxygen ion conductivity. Therefore, the present invention improves ion conductivity of the high-intensity anode with the reinforced mechanical physical property according to the introduction of 3YSZ by adding the oxide compound for forming the solid solution with the YSZ to improve the electrical characteristics, thereby making it possible to provide the anode including both the excellent intensity and ion conductivity.

The oxide compound for forming the solid solution with the yttria stabilized zirconia may be selected from any one of Ln₂O₃, CeO₂, and CaO or a mixture of two or more thereof. In this case, the Ln is Yb, Er, Dy, Gd, Sc, Sm, Ga, Bi, or Nd. However, the oxide compound for forming the solid solution is not limited to the above-mentioned example and therefore, any oxide compounds known to those skilled in the art can be used.

The oxide compound for forming the solid solution is included as the content of 0.1 to 20 parts by weight for every 100 parts by weight of the yttria stabilized zirconia, which is suitable to obtain the desired electrical characteristics as compared to the efficiency.

The electrolyte layer may be formed by coating and sintering, for example, YSZ or ScSZ, GDC, LDC, etc., using a slip coating method or plasma spray coating method, or the like, but is not specifically limited thereto.

The cathode layer may be formed by coating and sintering composition such as LSM, LSCF((La, Sr)(Co, Fe)O₃), etc., using a slip coating method or plasma spray coating method, or the like, but is not specifically limited thereto.

Meanwhile, the manufacturing method may further include sintering products resulted after the forming the anode layer, the forming the electrolyte layer, and the forming the cathode layer, respectively. In some cases, the cathode layer may be formed after being subjected to the sintering process after forming the anode layer and the electrolyte layer.

The method for manufacturing the solid oxide fuel cell according to another preferred embodiment of the present invention includes forming the anode supporting layer, forming the anode functional layer on the anode supporting layer, forming the electrolyte layer on the anode functional layer, and forming the cathode layer on the electrolyte layer.

The anode supporting layer may be formed by forming the predetermined raw mixing powder in the desired shape by, for example, extruding the predetermined raw mixing powder and then, the anode functional layer may be formed by coating the predetermined raw mixing powder using the slip coating or the plasma spray coating method, etc., and sintering it, but is not specifically limited thereto.

The anode supporting layer typically has the porous property transmitting gas to supply the fuel to the anode functional layer, while supporting the anode functional layer.

The anode supporting layer and the anode functional layer may be formed from the raw mixing powder made of the same host material. The host material may be made as described above in the anode layer according to the preferred embodiment.

The electrolyte layer may be formed by coating and sintering YSZ or ScSZ, GDC, LDC, etc., using a slip coating method or plasma spray coating method, or the like, but is not specifically thereto.

The cathode layer may be formed by coating and sintering composition such as LSM, LSCF((La, Sr)(Co, Fe)O₃), etc., using a slip coating method or plasma spray coating method, or the like, but is not specifically thereto.

Meanwhile, the manufacturing method may further include sintering products resulted after the forming the anode layer, the forming the electrolyte layer, and the forming the cathode layer, respectively. In some cases, the cathode layer may be formed after being subjected to the sintering process after forming the anode layer and the electrolyte layer.

As described above, according to the present invention, the anode layer or the anode supporting layer of the fuel cell uses the YSZ composite and the oxide compound for forming the solid solution with the YSZ to the oxygen vacancy concentration, thereby making it possible to provide the method for manufacturing the solid oxide fuel cell including the anode with excellent mechanical properties and ion conductivity.

According to one preferred aspect of the present invention, it can increase the ion conductivity of 3YSZ to largely improve the electrical characteristics when the gas, electrolyte, and electrode react with each other at the triple phase boundary by adding an oxide compound for forming the solid solution with the YSZ to the anode added with the 3YSZ having low ion conductivity and excellent intensity.

According to another aspect of the present invention, it can provide the fuel cell including the anode support having high intensity and high ion conductivity by introducing the 3YSZ into the anode support of the fuel cell using the 8YSZ to improve the intensity and adding and supplementing the YSZ having relatively low ion conductivity and the oxide compound for forming the solid solution according to the introduction of the 3YSZ.

Although the preferred embodiments of the present invention have been disclosed for illustrative purposes, they are for specifically explaining the present invention and thus the solid oxide fuel cell and a manufacturing method thereof according to the present invention are not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A solid oxide fuel cell, comprising:
an anode layer, a cathode layer, and an electrolyte layer interposed between the anode layer and the cathode layer,
wherein the anode layer includes:
a conductive material;
yttria stabilized zirconia (YSZ); and
an oxide compound for forming a solid solution with the yttria stabilized zirconia.

2. The solid oxide fuel cell as set forth in claim 1, wherein the yttria stabilized zirconia includes zirconia stabilized with 3 mol % of yttria (3YSZ).

3. The solid oxide fuel cell as set forth in claim 1, wherein the yttria stabilized zirconia includes 25 to 100 wt % of zirconia stabilized with 3 mol % of yttria (3YSZ) and 0 to 75 wt % of zirconia stabilized with 8 mol % of yttria (8YSZ).

4. The solid oxide fuel cell as set forth in claim 1, wherein the oxide compound for forming the solid solution is selected from a group consisting of Ln₂O₃, CeO₂, CaO, and a mixture thereof and the Ln is Yb, Er, Dy, Gd, Sc, Sm, Ga, Bi, or Nd.

5. The solid oxide fuel cell as set forth in claim 1, wherein the oxide compound for forming the solid solution is included as the content of 0.1 to 20 parts by weight for every 100 parts by weight of the yttria stabilized zirconia.

6. The solid oxide fuel cell as set forth in claim 1, wherein the anode layer includes an anode supporting layer and an anode functional layer.

7. The solid oxide fuel cell as set forth in claim 6, wherein the anode supporting layer includes:
a conductive material;
yttria stabilized zirconia; and
an oxide compound for forming a solid solution with the yttria stabilized zirconia.

8. The solid oxide fuel cell as set forth in claim 7, wherein the yttria stabilized zirconia includes 25 to 100 wt % of zirconia stabilized with 3 mol % of yttria (3YSZ) and 0 to 75 wt % of zirconia stabilized with 8 mol % of yttria (8YSZ).

9. The solid oxide fuel cell as set forth in claim 7, wherein the oxide compound for forming the solid solution is selected from a group consisting of Ln₂O₃, CeO₂, CaO, and a mixture thereof and the Ln is Yb, Er, Dy, Gd, Sc, Sm, Ga, Bi, or Nd.

10. The solid oxide fuel cell as set forth in claim 7, wherein the oxide compound for forming the solid solution is included as the content of 0.1 to 20 parts by weight for every 100 parts by weight of the yttria stabilized zirconia.

11. A method for manufacturing a solid oxide fuel cell, comprising:
forming an anode layer;
forming an electrolyte layer on the anode layer; and
forming a cathode layer on the electrolyte layer,
wherein the anode layer includes:
a conductive material;
yttria stabilized zirconia; and
an oxide compound for forming a solid solution with the yttria stabilized zirconia.

12. The method for manufacturing a solid oxide fuel cell as set forth in claim 11, wherein the yttria stabilized zirconia includes 25 to 100 wt % of zirconia stabilized with 3 mol % of yttria (3YSZ) and 0 to 75 wt % of zirconia stabilized with 8 mol % of yttria (8YSZ).

13. The method for manufacturing a solid oxide fuel cell as set forth in claim 11, wherein the solid solution is selected from a group consisting of Ln₂O₃, CeO₂, CaO, and a mixture thereof and the Ln is Yb, Er, Dy, Gd, Sc, Sm, Ga, Bi, or Nd.

14. The method for manufacturing a solid oxide fuel cell as set forth in claim 11, wherein the oxide compound for forming the solid solution is included as the content of 0.1 to 20 parts by weight for every 100 parts by weight of the yttria stabilized zirconia.

15. The method for manufacturing a solid oxide fuel cell as set forth in claim 11, wherein the forming the anode layer includes:
forming an anode supporting layer; and
forming an anode functional layer on the anode supporting layer.

16. The method for manufacturing a solid oxide fuel cell as set forth in claim 15, wherein the anode supporting layer includes:
a conductive material;
yttria stabilized zirconia; and
an oxide compound for forming a solid solution with the yttria stabilized zirconia.

17. The method for manufacturing a solid oxide fuel cell as set forth in claim 16, wherein the yttria stabilized zirconia includes 25 to 100 wt % of zirconia stabilized with 3 mol % of yttria (3YSZ) and 0 to 75 wt % of zirconia stabilized with 8 mol % of yttria (8YSZ).

18. The method for manufacturing a solid oxide fuel cell as set forth in claim 16, wherein the oxide compound for forming the solid solution is selected from a group consisting of Ln₂O₃, CeO₂, CaO, and a mixture thereof and the Ln is Yb, Er, Dy, Gd, Sc, Sm, Ga, Bi, or Nd.

19. The method for manufacturing a solid oxide fuel cell as set forth in claim 16, wherein the oxide compound for forming the solid solution is included as the content of 0.1 to 20 parts by weight for every 100 parts by weight of the yttria stabilized zirconia.

20. The method for manufacturing a solid oxide fuel cell as set forth in claim 11, further comprising sintering products resulted after the forming the anode layer, the forming the electrolyte layer, and the forming the anode layer, respectively.
